(19) United States
(12) Patent Application Publication
(10) Pub. No.: US 2014/0054014 A1
(43) Pub. Date: Feb. 27, 2014

(54) HEAT PIPE AND METHOD FOR MAKING THE SAME

(71) Applicants: SHENG-LIANG DAI, KunShan City (CN); YU-LIANG LO, Tu-Cheng (TW); JIA-HONG WU, Tu-Cheng (TW)

(72) Inventors: SHENG-LIANG DAI, KunShan City (CN); YU-LIANG LO, Tu-Cheng (TW); JIA-HONG WU, Tu-Cheng (TW)

(21) Appl. No.: 13/652,603

(22) Filed: Oct. 16, 2012

(30) Foreign Application Priority Data
Aug. 23, 2012 (CN) 2012103021231

(51) Int. Cl. F28D 15/04; B29C 45/14

(52) U.S. Cl. 165/104.26; 264/108

(57) ABSTRACT

A heat pipe includes an elongated tube, a wick structure arranged on an inner wall of the tube, and a working fluid filled in the tube. The wick structure defines elongated liquid channels for condensed working fluid flowing therethrough. An elongated vapor channel is defined in the tube for vaporized working fluid flowing therethrough. The vapor channel is spaced from the liquid channels by the wick structure.

### BACKGROUND

1. Technical Field

The disclosure generally relates to heat transfer apparatuses, and particularly to a heat pipe with high heat transfer performance and a method for manufacturing the same.

2. Description of Related Art

Heat pipes have excellent heat transfer performance and are therefore effective means for transfer or dissipation of heat from heat sources. Currently, heat pipes are widely used for removing heat from heat-generating components such as central processing units (CPUs) of computers. A heat pipe is usually a vacuum casing containing therein a working medium, which is employed to carry, under phase transitions between liquid state and vapor state, thermal energy from one section of the heat pipe (typically referring to as the “evaporator section”) to another section thereof (typically referring to as the “condenser section”). Preferably, a wick structure is provided inside the heat pipe, lining an inner wall of the casing, for drawing the working medium back to the evaporator section after it is condensed at the condenser section. The wick structure currently available for the heat pipe includes fine grooves integrally formed at the inner wall of the casing, screen mesh or fiber inserted into the casing and held against the inner wall thereof, or sintered powders combined to the inner wall of the casing by sintering process.

In operation, the evaporator section of the heat pipe is maintained in thermal contact with a heat-generating component. The working medium contained at the evaporator section absorbs heat generated by the heat-generating component and then turns into vapor. Due to the difference of vapor pressure between the two sections of the heat pipe, the generated vapor moves and thus carries the heat towards the condenser section where the vapor is condensed into condensate after releasing the heat into ambient environment by, for example, fins thermally contacting the condenser section. Due to the difference in capillary pressure which develops in the wick structure between the two sections, the condensate is then brought back by the wick structure to the evaporator section where it is again available for evaporation.

Since the direction of the condensate drawn back to the evaporator section is opposite to the direction of the vapor moving to the condenser section, the vapor exerts an opposite resistance to the condensate, which reduces the heat transfer capability of the heat pipe. If the condensate is not quickly brought back to the evaporator section from the condenser section, the heat pipe will suffer a dry-out problem at the evaporator section.

Therefore, it is desirable to provide a heat pipe with an improved heat transfer capability and a method for manufacturing such a heat pipe.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a transverse cross-sectional view of a heat pipe in accordance with a first embodiment of the present disclosure.

FIG. 2 is a longitudinal cross-sectional view of the heat pipe of FIG. 1.

FIG. 3 is a transverse cross-sectional view of a heat pipe in accordance with a second embodiment of the present disclosure.

FIG. 4 is a transverse cross-sectional view of a mold used in a method for manufacturing the heat pipe of FIG. 1 in accordance with one embodiment of the present disclosure.

FIG. 5 shows a process of manufacturing the heat pipe of FIG. 1 by using the mold of FIG. 4.

### DETAILED DESCRIPTION

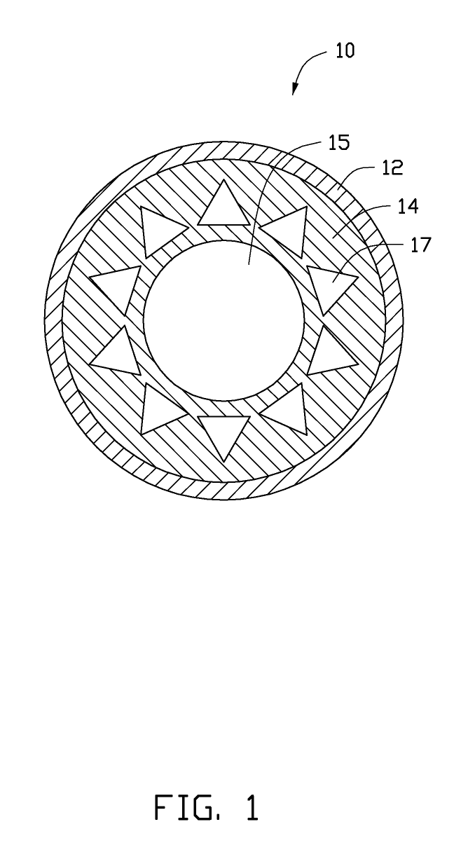

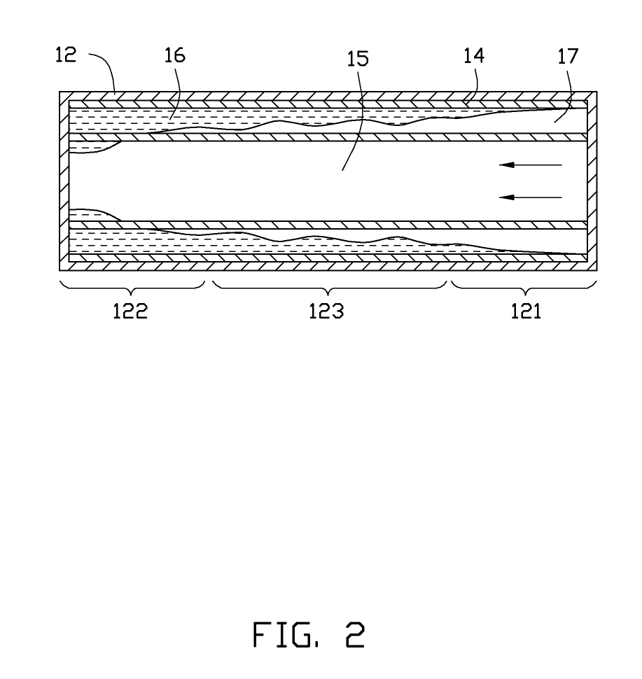

Referring to FIGS. 1 and 2, a heat pipe 10 in accordance with a first embodiment of the disclosure is shown. The heat pipe 10 includes an elongated, round tube 12 containing a working fluid 16 therein, and a wick structure 14.

The tube 12 is made of a highly thermally conductive material such as copper or aluminum. The tube 12 includes an evaporator section 121, a condenser section 122 opposite to the evaporator section 121, and an adiabatic section 123 disposed between the evaporator section 121 and the condenser section 122.

The working fluid 16 is saturated in the wick structure 14 and is usually selected from a liquid such as water, methanol, or alcohol, which has a low boiling point and is compatible with the wick structure 14. Thus, the working fluid 16 can easily evaporate to vapor when it receives heat at the evaporator section 121 of the heat pipe 10.

The wick structure 14 is evenly attached to an inner wall of the tube 12. The wick structure 14 extends along an axial direction of the tube 12 from the evaporator section 121 to the condenser section 122. The wick structure 14 is selected from a porous structure such as sintered powder, screen mesh, or bundles of fiber, and provides a capillary force to drive condensed working fluid 16 at the condenser section 122 to flow towards the evaporator section 121 of the heat pipe 10. The wick structure 14 has a porosity in a range from 20 to 60 percent.

The wick structure 14 defines a plurality of elongated liquid channels 17 therein for condensed working fluid 16 flowing therethrough. Each liquid channel 17 extends along the axial direction of the tube 12 from the evaporator section 121 to the condenser section 122. An area of a transverse cross-section of each liquid channel 17 is less than 7 square millimeters. A total area of the transverse cross-sections of the liquid channels 17 is in a range from 40 to 80 percent of an area of a transverse cross-section of the wick structure 14. An elongated vapor channel 15 is defined in a center of the tube 12 and surrounded by the wick structure 14 for vaporized working fluid 16 flowing therethrough. The vapor channel 15 is spaced from the liquid channels 17 by the wick structure 14 to reduce opposite resistance of the vaporized working fluid 16 exerted on the condensed working fluid 16. The liquid channels 17 surround the vapor channel 15 and are spaced from each other with a same interval. A transverse cross-section of each liquid channel 17 along a radial direction of the tube 12 is a triangle. The transverse cross-section of each liquid channel 17 along the radial direction of the tube 12 slightly gradually decreases from the condenser section 122 to the evaporator section 121. Simultaneously, a transverse cross-section of the wick structure 14 along the radial direction of the tube 12 slightly gradually increases from the condenser section 122 to the evaporator section 121, so that the capillary force to draw the condensed working fluid 16 at the condenser section 122 is reinforced.

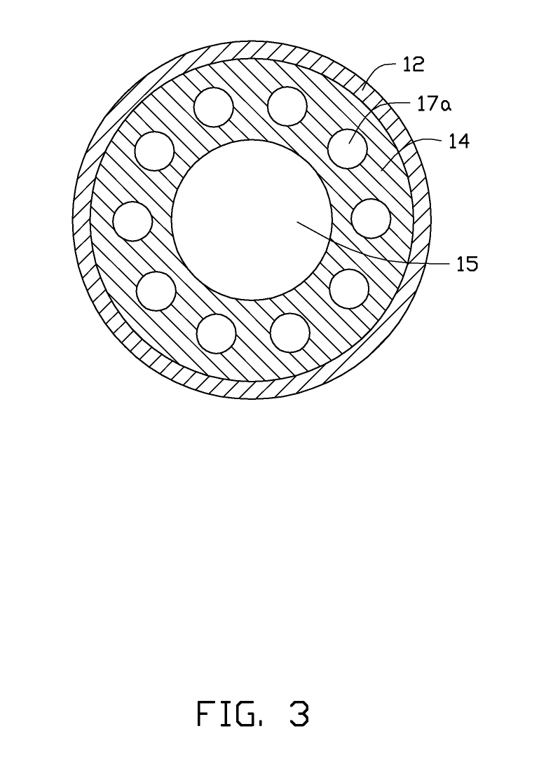

Referring to FIG. 3, in a second embodiment of the present disclosure, the transverse cross-section of each liquid channel 17a along the radial direction of the tube 12 is circular.

In the present heat pipe 10, the elongated liquid channels 17 are defined in the wick structure 14 for condensed working fluid 16 flowing therethrough. This facilitates improvement of the porosity of the wick structure 14. Simultaneously, the wick structure 14 is selected from sintered powder, screen mesh, or bundles of fiber, and has relatively small particle size. This facilitates increase of the capillary force of the wick structure 14. Therefore, compared with conventional heat pipes, the heat pipe 10 has higher porosity and higher capillary force, this facilitates improving the heat transfer capability of the heat pipe 10. Further, the vapor channel 15 is spaced from the liquid channels 17 by the wick structure 14, opposite resistance of the vaporized working fluid 16 exerted on the condensed working fluid 16 is reduced.

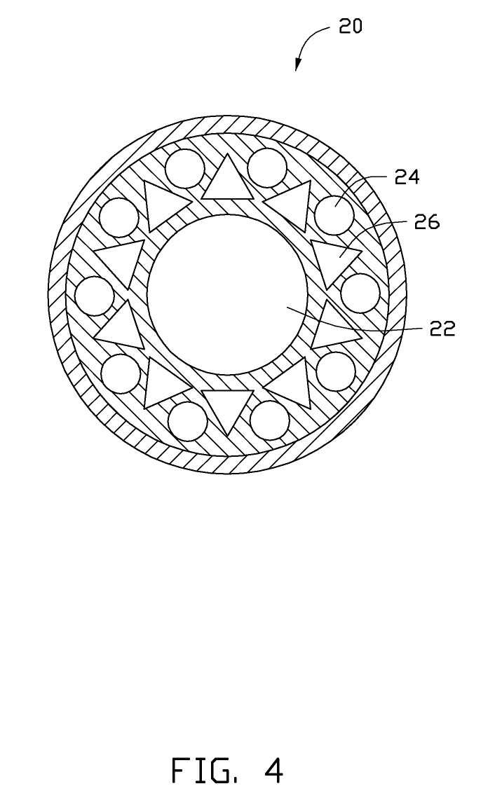

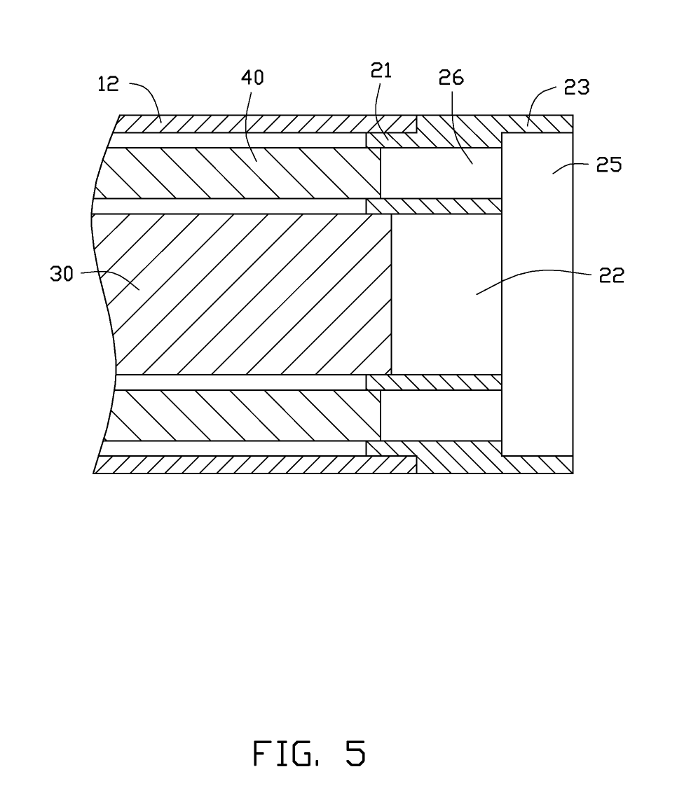

Referring to FIGS. 4 and 5, a method for manufacturing the heat pipe 10 includes the following steps:

The first step is to provide a mold 20. A transverse cross-section of the mold 20 along a radial direction thereof is circular. The mold 20 defines a cylindrical mandrel hole 22 in a center thereof. A plurality of circular filling holes 24 and a plurality of triangular positioning holes 26 are defined in the mold 20 around the mandrel hole 22. The filling holes 24 and the positioning holes 26 alternately surround the mandrel hole 22. The filling holes 24 are spaced from each other with a same interval. The positioning holes 26 are spaced from each other with a same distance. The mold 20 includes a first end 21 and a second end 23 along an axial direction thereof. The first end 21 has an outer diameter smaller than that of the second end 23. An opening 25 is defined in the second end 23. The opening 25 communicates with the mandrel hole 22, the filling holes 24 and the positioning holes 26.

The second step is to provide the hollow tube 12 and fix the first end 21 of the mold 20 in an opening of the tube 12.

The third step is to provide a cylindrical mandrel 30 and a plurality of triangular bars 40, and place the cylindrical mandrel 30 in the tube 12 along the mandrel hole 22 of the mold 20 and place the triangular bars 40 in the tube 12 along the positioning holes 26 of the mold 20. One end of the mandrel 30 is received in the mandrel hole 22 of the mold 20. One end of each bar 40 is received in a corresponding positioning hole 26 of the mold 20. A size of a cross-section of each bar 40 is equal to that of each positioning hole 26 of the mold 20. The mandrel 30 has a diameter equal to that of the mandrel hole 22 of the mold 20.

The fourth step is to provide an amount of thermally conductive powder i.e. metal powder and fill the metal powder into the tube 12 along the filling holes 24 of the mold 20. The metal powder has a particle size less than 74 μm. The tube 12 with the mandrel 30, the bars 40 and the metal powder is heated at a high temperature until the metal powder sinters to form the wick structure 14 evenly attached to the inner wall of the tube 12.

The fifth step is to draw the mandrel 30 and the bars 40 out of the tube 12. The liquid channels 17 are formed in the tube 12 corresponding to positions of the bars 40. The vapor channel 15 is formed in the tube 12 corresponding to a position of the mandrel 30. The vapor channel 15 is spaced from the liquid channels 17 by the wick structure 14.

The sixth step is to vacuum an interior of the tube 12 and inject the working medium 16 into the tube 12, and seal the opening of the tube 12.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A heat pipe comprising:
an elongated tube;
a working fluid contained in the tube; and
a wick structure received in the tube and arranged on an inner wall of the tube, the wick structure defining a plurality of elongated liquid channels for condensed working fluid flowing therethrough, an elongated vapor channel being defined in the tube for vaporized working fluid flowing therethrough, the vapor channel being spaced from the liquid channels by the wick structure.

2. The heat pipe of claim 1, wherein the vapor channel is defined in a center of the tube, the liquid channels surrounding the vapor channel, the tube comprising an evaporator section and an opposite condenser section, the liquid channels and the vapor channel extending along an axial direction of the tube from the evaporator section to the condenser section.

3. The heat pipe of claim 1, wherein a transverse cross-section of each liquid channel along a radial direction of the tube is a triangle.

4. The heat pipe of claim 1, wherein a transverse cross-section of each liquid channel along a radial direction of the tube is circular.

5. The heat pipe of claim 1, wherein the liquid channels surround the vapor channel and are spaced from each other with a same interval.

6. The heat pipe of claim 1, wherein the wick structure has a porosity in a range from 20 to 60 percent.

7. The heat pipe of claim 1, wherein an area of a transverse cross-section of each liquid channel is less than 7 square millimeters.

8. The heat pipe of claim 1, wherein a total area of transverse cross-sections of the liquid channels is in a range from 40 to 80 percent of an area of a transverse cross-section of the wick structure.

9. The heat pipe of claim 1, wherein wick structure is selected from sintered powder, screen mesh, or bundles of fiber.

10. A method for manufacturing a heat pipe comprising the steps of:
providing a mold, the mold defining a mandrel hole in a center thereof, a plurality of filling holes and a plurality of positioning holes around the mandrel hole;
providing a hollow tube and fixing the mold at an opening of the tube;
providing a mandrel and a plurality of bars, placing the mandrel in the tube along the mandrel hole of the mold and placing the bars in the tube along the positioning holes of the mold, one end of the mandrel being retained in the mandrel hole of the mold, one end of each bar being retained in a corresponding positioning hole of the mold;
providing an amount of metal powder and filling the metal powder into the tube along the filling holes of the mold, the metal powder being heated to form a wick structure evenly attached to an inner wall of the tube;
drawing the mandrel and the bars out of the tube, a plurality of liquid channels being formed in the tube corresponding to positions of the bars, a vapor channel being formed in the tube corresponding to a position of the mandrel, the vapor channel being spaced from the liquid channels by the wick structure; and
injecting a working medium into the tube and sealing the opening of the tube.

11. The method of claim 10, wherein a transverse cross-section of each positioning hole along a radial direction of the mold is triangular.

12. The method of claim 10, wherein a transverse cross-section of mandrel hole along a radial direction of the mold is circular.

13. The method of claim 10, wherein the filling holes and the positioning holes alternately defined in the mold.

14. The method of claim 10, wherein the mold comprises a first end and a second end along an axial direction thereof, the first end having an outer diameter smaller than that of the second end, the first end of the mold being fixed in the opening of the tube.

15. The method of claim 14, wherein an opening is defined in the second end of the mold, the opening communicating with the mandrel hole, the filling holes and the positioning holes.

16. The method of claim 10, wherein the metal powder has a particle size less than 74 μm.
